(19) United States
(12) Patent Application Publication
(10) Pub. No.: US 2012/0230363 A1
(43) Pub. Date: Sep. 13, 2012

(54) METHOD FOR CONTROLLING THE MELT STATE WHEN PRODUCING A PLASTIC WELD SEAM

(75) Inventors: Simon Ott, Luzern (CH); Ulrich Gubler, Buonas (CH)

(73) Assignee: LEISTER TECHNOLOGIES AG, Kagiswil (CH)

(21) Appl. No.: 13/509,337

(22) PCT Filed: Nov. 11, 2010
(86) PCT No.: PCT/IB2010/002889

§ 371 Date: Jun. 1, 2012

(30) Foreign Application Priority Data
Nov. 14, 2009 (EP) 09014253.0

(51) Int. Cl. G01K 11/06

(52) U.S. Cl. 374/21; 374/E11.006

(57) ABSTRACT

The invention relates to a method for determining the temperature-dependent state, in particular the melt state and/or the melt quantity of thermoplastic material when producing a weld seam (6), for example for joining thermoplastic parts (7, 7′) by means of a plastic welding device. For process control purposes, a temperature-dependent electric state variable of the thermoplastic material of the plastic parts (7, 7′) is measured continuously with and without applying heat to the plastic parts (7, 7′) along the weld seam (6) and compared to a target value or to benchmark values. In the method according to the invention, the electric state variable that is used is preferably the permittivity of the plastic parts (7, 7′). The permittivity is determined by means of the capacitor assembly (1) wherein the plastic material is used as the dielectric between the electrodes (3, 4) of the capacitor assembly (1). The capacitors (2) of the capacitor assembly (1) are preferably operated at different frequencies for the determination of the permittivity.

### TECHNICAL FIELD OF THE INVENTION

The invention relates to a method for determining the temperature-dependent state, in particular the melt state and/or the melt quantity of thermoplastic material when producing a weld seam of thermoplastic material by means of a plastic welding device.

### DISCUSSION OF RELATED ART

In thermoplastic welding, plastic parts of thermoplastic material to be joined are heated locally in order to form a welding seam and are pressed against each other at the same time or thereafter. In this way, it is possible to securely join the plastic parts to each other, for example plastic webs, plastic sheets, plastic foil, injection-molded plastic parts, or extruded plastic parts with edge areas that overlap, butt, or are arranged at a slight distance from each other. Depending on the arrangement of the plastic parts relative to each other, the welding seam is produced by means of plastified material of the plastic parts themselves, or with externally supplied elastic melting material consisting of thermoplastic material. In a case of overlapping plastic parts, in particular limp plastic parts, the plastic welding seams can be produced in a very simple way, i.e. without using additional plasticized strands of plastic material, by means of hand-held welding devices or automatic welding devices.

Automatic welding devices that perform the welding process in a fully automatic way produce high-quality welding seams that not only permanently join the plastic parts that have high tensile and pressure strength, but are also absolutely leakproof. Injection-molded or extruded parts are usually welded with automatic welding devices that are fixed in location and are based on hot dies, vibration, ultrasound, infrared radiation, or lasers. Sheet-type plastic materials such as webs, sheets, or foils are laid out and welded with moving automatic welding devices. In a multitude of configurations, they are used for welding plastic sealing sheets in above-ground and underground construction, in tunnel, dump, and marine construction. In particular, they are used for overlap welding of plastic webs where the webs are heated at their edges by means of a heating wedge or hot air, are melted or plasticized, and are then joined surface-to-surface under pressure by means of pressure rolls, forming a welding seam. Here, the hot air nozzle or the heating wedge that is heated electrically or by means of hot air is guided between the webs while contacting both foil webs.

The placement and welding of sealing webs are subject to high quality demands since even small defects may have expensive consequences. Properly installed plastic sealing webs are joined in an absolutely leakproof way, i.e. there are no pore channels in the area of the welding seam through which water might pass due to hydrostatic pressure, gravity, and capillary action. In order to achieve optimum welding results, it is common to use modern automatic welding devices that monitor the critical welding parameters like heating wedge temperature, contact pressure, welding path, and welding speed, and to control them automatically in conjunction with pre-set nominal values. They show the actual values on a display device and issue an acoustic warning signal in the event of impermissible deviations from the nominal values. In addition, such automatic welding devices are usually also equipped with a data acquisition system that electronically stores the welding parameters at regular intervals, for example once per second. After the seam has been welded, these data can be read, shown jointly on a display, printed out and analyzed. Frequently, however, this makes it possible to show only areas of abrupt thickness changes of the welding seam, where the contact pressure changed abruptly. It is then possible to visually inspect such areas, evaluate them, and repair them if necessary.

For this reason, in critical applications the sealing webs are often joined largely mechanically by means of overlap double welding seams. This produces a test channel between the two parallel welding seams, making it possible to reliably test the welding seams for defects by applying pressure to the test channel. This testing for defective areas in such an overlap double welding seam is a costly and therefore unfavorable feature. Overlap single welding seams that, like the double welding seams, can be produced with heating wedge automatic welding devices with a controlled and documented process control cannot be tested in any reliable manner for possible defective areas; it is only possible to evaluate the stored process data as described above.

### SUMMARY OF THE INVENTION

Starting with prior art as described above, the invention addresses the problem of proposing a method for reliably testing the quality of a welding seam while it is being produced, for double as well as single welding seams.

According to the invention, this problem is solved by a process with the characteristics of claim 1. Additional favorable embodiments are specified in the related claims.

It is the basic premise of the invention to detect potential defective areas of the welding seam during the production process by continuously determining at the local welding spot the temperature-dependent state, in particular the melt state and/or the melt quantity of the thermoplastic material that needs to reach melting temperature for joining the plastic parts and which forms the welding seam after hardening. The term temperature-dependent state also includes states caused by temperature-dependent changes in the plastic material that occur prior to the actual melting (that is visible and makes the welding possible), i.e. representing an initial stage.

The method according to the invention for determining the temperature-dependent state, in particular the melt state and/or the melt quantity of thermoplastic material when producing a weld seam of thermoplastic material by means of a plastic welding provides for the following process steps:

First, the thermoplastic plastic material, for example for joining two plastic parts, is heated to the welding temperature in the area of the welding seam to be formed, with the electric state variable during the application of heat for the purpose of forming a plastic material melt being preferably determined continuously and stored for a further evaluation of the state of the material. In order to determine the temperature-dependent state or melt state, in particular the degree of plastification and the melt quantity in the three spatial dimensions of the thermoplastic plastic material at the welding spot, the measured values are computed with each other and/or with reference or empirical values, with and without application of heat. The state variable determined in this way is a measure for the quality of the welding seam and can be stored or used for controlling the automatic welding device. In a last step, the state variable can be compared with a target value and/or two marginal values that trigger a warning signal for the operator. The reference or empirical values of an electric state variable of the thermoplastic material of the plastic parts can be determined and stored in the area of the welding seam without application of heat to the plastic parts, or, as an alternative, instead of this measurement to be performed first, empirical values or material databases can be applied.

Preferably, the electric state variable is determined by measuring, with the measuring being performed continuously or at suitable time intervals at the location of the heating or plastification that begins with the application of heat; the surface temperature of the plastic material at this location may be measured as additional information. In this way, it is possible to determine precisely when the plastification of the thermoplastic material begins, and when the end state of the plastification is reached. In its end state, the plastification and the melt quantity of thermoplastic material at the local welding spot are suitable for producing a high-quality welding seam that joins the thermoplastic parts firmly and leakproof with each other.

The result of the state measurement can be used as a measuring and control variable. As a measuring variable, it can be fed into the electronic control system of the automatic welding device for the purpose of triggering an acoustical and/or optical alarm in case of a locally insufficient melt state or if the local melt quantity is too small or too large during the production of the welding seam. As a control variable, it can be fed into the electronic control system of the automatic welding device for appropriate adjustment of the welding parameters of the automatic welding devices, for example the heating wedge temperature, the contact pressure, or the welding speed. Preferably, the electric state variable of the thermoplastic material is measured in the welding seam area before and during the welding process, and is used for adjusting the machine parameters of the automatic welding device.

In a preferred embodiment of the invention, the permittivity of the thermoplastic material is used as the electric state variable. Permittivity is a physical variable that indicates the permeability of a material for electrical fields. Instead of permittivity, the obsolete term dielectric constant is sometimes used. Permittivity therefore designates a material characteristic of electrically insulating, polarized and non-polarized materials that are also called dielectrics. With such materials, the charge carriers generally do not move freely. When introduced into a plate capacitor, they influence its capacitance. The charge carriers that are not free can be polarized by an external electrical field. As a consequence, with the same voltage being applied, a plate capacitor with a dielectric material as an intermediate layer is capable of storing more energy than the same plate capacitor with a separating air layer. It is generally known that like all plastic materials, thermoplastic materials have a multitude of free polarizable charge carriers. The permittivity of most thermoplastic materials is temperature-dependent and can therefore be used as a variable for determining the temperature-dependent melt state and therefore also the melt quantity of the thermoplastic material during the welding process. The measured permittivity also permits conclusions regarding the temperature inside a plastic material.

Measuring processes for determining the electricity coefficient or the permittivity variable are known to a person skilled in the art and do therefore not require a detailed explanation for the dielectric spectroscopy applied in the process specified above. Preferably, in the process according to the invention, the permittivity is determined by means of a capacitor assembly wherein the plastic material is used as dielectric between electrodes of the capacitor assembly. For capacitor assembly, a single plate capacitor or multi-plate capacitors arranged as an array can be used. In an array, the plate capacitors may be arranged along or perpendicular to the welding seam. In the process according to the invention, for example, the permittivity is determined indirectly by measuring the amplitude and the phase shift of the voltage and the current with a sine-shaped load applied to the plate capacitor. The average value that can be determined in this way is dependent on the frequency of the alternating voltage and on the temperature of the plastic material between the capacitor plates. It is also possible to measure, alternatingly or simultaneously, with several frequencies, and to compute in suitable fashion the amplitudes and phase shifts at different frequencies. As an alternative, it is also possible to apply single pulses or suitable pulse sequences to the plate capacitors.

The associated electrodes of the capacitor assembly can be arranged for this purpose on opposing sides of the plastic material or on one side of the thermoplastic material. With the unilateral arrangement, the principle requires for them to be arranged next to each other at a distance, while with a two-sided arrangement, they can be arranged overlapping each other completely or partially, or non-overlapping and laterally displaced relative to each other.

In a favorable embodiment of the invention, one part of the welding device is used as one electrode and a surface located behind the thermoplastic material is used as the other electrode. For example, this surface can be a bottom, wall, or top surface on which plastic parts are attached for permanent covering, or a support surface that serves only for joining plastic parts. In this case, special capacitor plates fixed on the welding device are not required. In other cases, however, capacitor plates connected with the welding device are required that form at least one pair of capacitor plates and are moved with the welding device along the welding seam to be produced. With several pairs of capacitor plates that together form the array of plate capacitors, the permittivity can be measured simultaneously or at different times at different locations of the thermoplastic material. This also makes it possible to determine, besides the width, length, and the thickness of the melt quantity of the thermoplastic material for the welding seam plastified by the application of heat, and besides the temperature-dependent state or melt state of the melt quantity, a comparative value of the non-heated non-plastified plastic material by means of various capacitors.

It proved to be advantageous to operate the capacitor assembly for determining the permittivity of the thermoplastic material with different frequencies. For each frequency, the capacitor assembly furnishes a special permittivity (amplitude and phase shift) that is suitably evaluated for the determination of the melt state and/or the melt quantity.

The application of the process according to the invention is not limited to automatic welding devices but is also possible and offers advantages with hand-held welding devices. The new process can be useful wherever welding seams are produced from a thermoplastic material for joining thermoplastic material parts. It can be used to advantage for quality assurance with all known plastic welding methods, for example with heating wedge, hot air, laser, infrared, and ultrasound welding.

Below, the invention is explained in detail with reference to schematic overview drawings. Additional characteristics of the invention are given in the following description of the invention in conjunction with the claims and the attached drawing.

### BRIEF DESCRIPTION OF THE DRAWINGS

FIG. 1 shows three possible capacitor assemblies (FIG. 1a to 1c) for determining the melt state and/or the melt quantity of thermoplastic material for a welding seam in accordance with the process according to the invention; and

FIG. 2 shows the possibilities for positioning the capacitor assemblies in FIG. 1 in relation to the welding seam on a welding device used for its production.

### DETAILED DESCRIPTION OF THE INVENTION

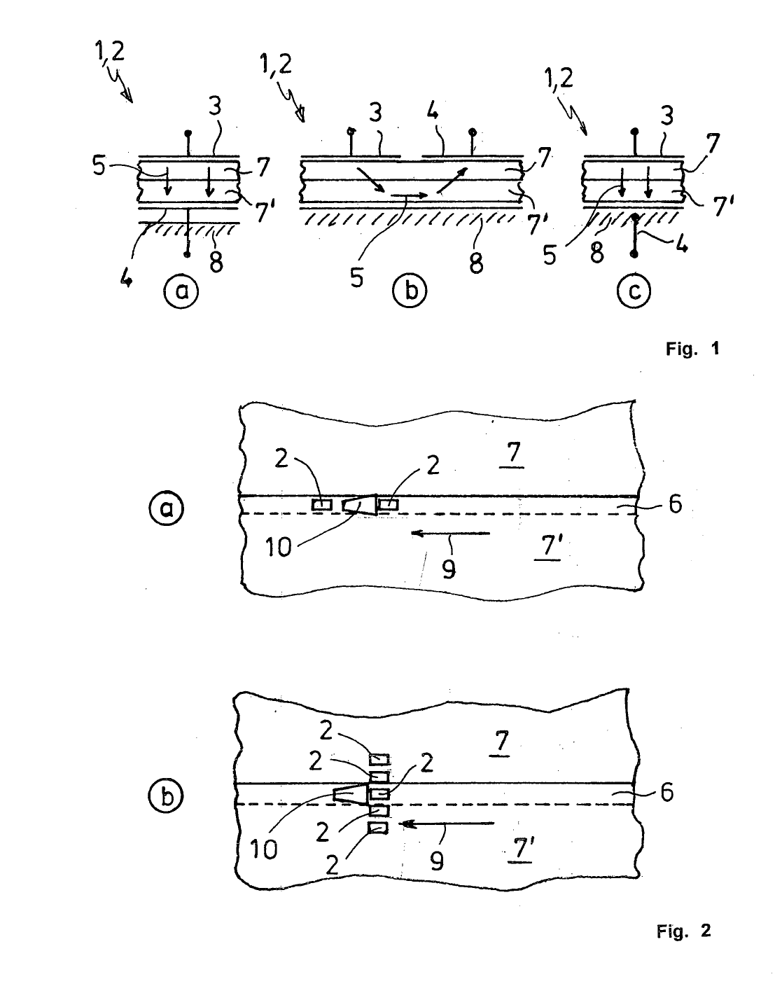

FIGS. 1a to 1c show three capacitor assemblies that are possible for the application of the invention and with which the melt state and/or the melt quantity of thermal plastic material can be determined during the production of a welding seam by means of measuring the permittivity. The capacitor assemblies 1 may each comprise a single capacitor 2 or several capacitors 2 arranged side-by-side as an array. Each capacitor 2 comprises a first electrode 3 and a second electrode 4 between which an electric alternating field 5 extends, with the electrodes 3, 4 being arranged in the area of the welding seam 6 (shown in FIG. 2) of plastic parts 7, 7′ made of thermoplastic material. The Figure shows a capacitor assembly 1 comprising only a single capacitor 2. The electrodes 3, 4 of the capacitor 2 are connected to a measuring device (not shown) that can operate the capacitor 2 at different frequencies while measuring amplitude and phase shift in order to determine the permittivity. A continuous evaluation of the measured results by means of the measuring device makes it possible to test whether sufficient melt material from the thermoplastic material is available as melt quantity for forming a durable welding seam. Making a distinction between plastified and non-plastified plastic material is possible because the electrical characteristics of thermoplastic material are temperature-dependent. A suitable melt state and a defined melt quantity are a fundamental requirement for a high-quality welded connection of the thermoplastic plastic parts 7, 7′.

In FIGS. 1a, 1b, the two electrodes 3, 4 are implemented as capacitor plates, with the capacitor plates 3, 4 in FIG. 1a facing each other diametrally while those in FIG. 1b are arranged side-by-side at a slight distance from each other. In FIG. 1c, the second electrode 4 is formed by a surface 8 on which the plastic parts 7, 7′ are arranged. The surface 8, for example, may be the ground surface on which emplaced sealing webs 7, 7′ are joined. Advantageously, at least one pair of electrodes 3, 4 is located close to the local welding spot of the welding seam. In the capacitor assemblies 1 shown in FIGS. 1a, 1c, the electrodes 3, 4 clamp the plastic parts 7, 7′ along the welding seam while in the capacitor assembly 1 shown in FIG. 1b the electrodes 3, 4 press the plastic parts 7, 7′ against the surface 8.

FIG. 2 shows two capacitor assemblies 1 with more than one capacitor 2. According to FIG. 2a, two capacitors 2 are used, and according to FIG. 2b five capacitors 2 are used for determining the local melt state and the local melt quantity for the production of the welding seam 6. In FIG. 2a, the two capacitors 2 are arranged in the welding direction 9 in front of and behind a heating device 10 of the plastic welding device (not shown). This makes it possible to continuously measure the differences of the permittivity along the welding seam 6 during the welding process. Instead of a single capacitor 2 in the welding direction 9 behind the heating device 10, several capacitors 2 arranged one behind the other in the welding direction 6 [sic] can be used in order to track the hardening of the welding seam 6. In FIG. 2b, the five capacitors 2 are arranged in a row as an array transversely to the welding direction 9. The length of the row is greater than the width of the welding seam 6 so that, by means of the two outermost capacitors 2, a differential measurement in relation to the remaining three capacitors 2 is also possible. The three capacitors 2 provided in the area of the welding seam 6 make it possible to reliably detect changes of the width of the welding seam 6. Depending on the intended or realized width of the welding seam 6, one to three of the inner capacitors 2 of the array face the welding seam 6 directly. The total number of capacitors 2 used for the array may be varied to a reasonable degree in order to achieve a better resolution. In addition, in the welding direction 9 in front of the heating device 10, an additional capacitor 2 (not shown in FIG. 2b) may be arranged in accordance with FIG. 2a.

When the electrodes 3, 4 face each other, their distance from each other is also relevant for determining the melt state and/or the melt quantity of the thermoplastic material of the plastic parts 7, 7′ close to the heating device 10. Also, the measuring result depends on the thickness of the plastic parts 7, 7′ and/or of the welding seam 6. The influences of the distance between the electrodes 3, 4 and of the material thickness of the plastic parts 7, 7′ are eliminated by the differential measurement. Or, by combining an inductive sensor with the capacitor assembly 1 or a separate Hall sensor, the corrected measurement of the permittivity or one that is independent of the material thickness is possible.

1. A method for determining the temperature-dependent state, in particular the melt state and/or the melt quantity of thermoplastic material when producing a weld seam of thermoplastic material by means of a plastic welding device, wherein the temperature-dependent state is derived from an electric state variable of the plastic material.

2. The method according to claim 1, comprising following steps:
A Determination and intermediate storage of an electric state variable of the thermoplastic material in the area of the welding seam during the application of heat for the purpose of forming a melt of plastic material for the production of the welding seam.
B Determination of the change of the electric state variable by comparing the state variables from the intermediate storage with each other and/or with additional measured or empirical values; and
C Comparison of the result of the change of the state variable with given nominal values and/or with given marginal values.

3. The method according to claim 2, wherein the electric state variable of the thermoplastic material in the area of the welding seam is measured, evaluated, and used for adjusting the machine parameters of the plastic welding device before and during the welding process.

4. The method according to claim 1, wherein the permittivity of the thermoplastic material is used as the electric state variable.

5. The method according to claim 4, wherein the permittivity is determined by means of a capacitor assembly, with the plastic material being used as dielectric between electrodes of the capacitor assembly.

6. The method according to claim 5, wherein a plate capacitor is used for the capacitor assembly.

7. The method according to claim 5, wherein an array of plate capacitors is used for the capacitor assembly.

8. The method according to claim 5, wherein the electrodes of the capacitor assembly are arranged on opposite sides of the plastic material.

9. The method according to claim 8, wherein parts of the welding device and a surface arranged behind the thermoplastic material are used as electrodes.

10. The method according to claim 5, wherein the electrodes are arranged side-by-side on one side of the plastic material.

11. The method according to claim 5, wherein the capacitor assembly is operated at different frequencies for determining the permittivity.

12. The method according to any one of the preceding claims, wherein, for the purpose of determining the temperature-dependent state in the area of the welding seam, an additional thickness measurement is performed during the application of heat whose result is taken into consideration in the determination of the change of the state variable.

13. The method according to claim 1, wherein, prior to the application of heat to form the plastic material melt for the welding seam, the electric state variable of the thermoplastic material in the area of the welding seam is determined and stored without the application of heat.
